(19) United States
(12) Patent Application Publication
(10) Pub. No.: US 2023/0326368 A1
(43) Pub. Date: Oct. 12, 2023

(54) LOCATION ADJUSTMENT WITH NON-VISUAL LOCATION FEEDBACK

(71) Applicant: Microsoft Technology Licensing, LLC, Redmond, WA (US)

(72) Inventors: Melanie Jo KNEISEL, Seattle, WA (US); Amos MILLER, Redmond, WA (US); Frazier Robert CARR, West Bridgford (GB); Steven Richard ABRAMS, Sonning Eye (GB)

(21) Appl. No.: 17/840,156

(22) Filed: Jun. 14, 2022

Related U.S. Application Data
(60) Provisional application No. 63/328,623, filed on Apr. 7, 2022.

(51) Int. Cl. G09B 21/00; G06F 3/04842; G06F 3/16; G06F 3/01; G06F 3/0346; G01C 21/36

(52) U.S. Cl. CPC G09B 21/003; G06F 3/04842; G06F 3/167; G06F 3/016; G06F 3/0346; G09B 21/006; G01C 21/3664; G01C 21/3626

(57) ABSTRACT

Generally discussed herein are devices, systems, and methods for location adjustment with non-visual location feedback. A method can include providing, by a visual map program, an indication of an initial selected location of a user-selected location, detecting, by data provided by an input component, an audio or tactile trigger by a user, responsive to the detecting, altering, by a first distance and a first direction, the initial selected location to a new location on the visual map program, and responsive to the altering, causing an output component to provide an audio or tactile indication of the new location.

### CLAIM OF PRIORITY

The present patent application claims the priority benefit of the filing date of U.S. provisional application No. 63/328,623 filed Apr. 7, 2022, the entire content of which is incorporated herein by reference.

### BACKGROUND

When using a visual map or navigation app, a user has an ability to select and later adjust a location on a visual map. Interacting with locations displayed on a visual map is often difficult or impossible for someone who is blind or has low-vision and uses a screen reader. This is, at least in part, because the user may not have access to the rich contextual information given by the features displayed on the visual map. This means that people who rely on screen readers are not able to make precise location adjustments that users who do not rely on a screen reader are able to make.

### SUMMARY

A device, system, method, and computer-readable medium configured for precise location adjustment on a visual map with screen reader and direction audio are provided. The device, system, and method provide improved precise location adjustment for those with low or no vision, diminished motor function, or other technological use impairments.

### BRIEF DESCRIPTION OF DRAWINGS

FIG. 1 illustrates, by way of example, a diagram of an embodiment of a user interface of a visual map program.

FIG. 2 illustrates, by way of example, a block diagram of an embodiment of a device configured for precise location adjustment with a screen reader and direction audio.

FIG. 3 illustrates, by way of example, a block diagram of a configuration menu indicating different settings that can be default or user-specified.

FIG. 4 illustrates, by way of example, a diagram of an embodiment of a user iteratively updating a location of the pin.

FIG. 5 illustrates, by way of example, a diagram of an embodiment of a method for improved location updates on a visual map.

FIG. 6 illustrates, by way of example, a block diagram of an embodiment of a machine (e.g., a computer system) to implement one or more embodiments.

### DETAILED DESCRIPTION

Embodiments regard providing precise incremental location adjustment using a screen reader and direction-indicative audio (e.g., spatial audio, words that expressly state the direction, or tone, font, prosody, volume, tenor, or a combination thereof that indicate direction, more details below). Embodiments include a user providing a trigger (e.g., an audio or tactile trigger) that causes the selected precise location to move a specified or default distance in a specified or default direction. Embodiments can further provide an audio or tactile indication of a new precise location after location adjustment. The distance a selected precise location is moved can be user-specified, default, or situation dependent. The screen reader is a form of assistive technology that renders text and image content as speech or braille output. People that are blind, have low-vision, are otherwise visually impaired, illiterate, or have a learning disability are the most common users of screen readers. The screen reader indicates what is happening on the screen in speech or braille form. “Precise”, as used herein, means represented as a single coordinate or point. A coordinate can be represented in a variety of ways and in a variety of coordinate systems. A coordinate uses one or more numbers to uniquely determine a position or point. A coordinate can be specified in a variety of formats, such as (x, y, z), (latitude, longitude, altitude), (azimuth, elevation, range), (radial distance, polar angle, azimuth angle), among others.

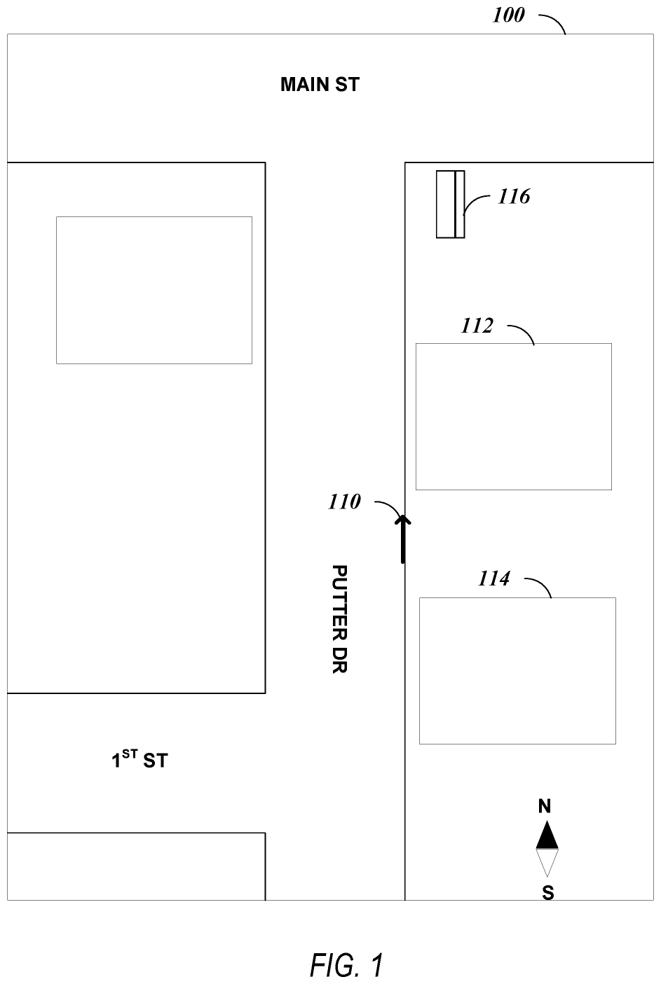

FIG. 1 illustrates, by way of example, a diagram of an embodiment of a user interface 100 of a visual map program. The user interface 100 provides a visual depiction of a geographic or virtual region. In the depicted user interface, a user has dropped a pin 110 on Putter Dr. between buildings 112 and 114. Note that the pin 110 is just one visual way of indicating a location. Another way of indicating location includes verbally indicating the location. Embodiments generally apply to adjusting a location on a visual map in a more accessible manner. Consider an instance in which the user wants to locate the pin 110 to be at a bus stop 116. The user can want to navigate to the bus stop 116, determine a distance to the bus stop 116, store the bus stop 116 as a common destination, or the like. To accomplish the pin 110 movement from its current location to the bus stop 116, the user, in most navigation apps, will select the pin 110 and then drag the pin 110 to the desired location, the bus stop 116 in this example. Selecting the pin 110 can include touching a screen on which the user interface 100 is presented with an object (e.g., finger, stylus, screen pen, or the like). Selecting the pin 110 can include activating a mouse button (e.g., by pressing the button) of a mouse while a cursor is over the pin 110 and keeping the mouse button activated. A visually impaired person, a person with a motor function impairment, a person with a learning disability, or the like, can struggle to precisely move the pin 110 to a desired location in any of the manners described. A visually impaired person may not be able to see the visual features of the map to know where the pin 110 is currently located (relative to the other features displayed on the map) and how far and in what direction the pin 110 should be moved to reach the desired location, in this case, the bus stop 116. Note that there are certain locations which are not easily accessed through other means, like searching, so selection is best done by indicating, through a long press, tap or like, of a location on a visual map.

Embodiments allow a user to incrementally move the pin 110 towards a destination (the bus stop 116 in the example of FIG. 1) without tactile means (the mouse and finger dragging described). The increment can be user-specified or default. The direction to move the pin 110 can be based on a heading of the device that is presenting the user interface 100, a heading determined based on headphones or a headset the user is wearing, an audibly provided user-heading, or other heading. Embodiments can provide a user with an audible, braille, haptic feedback, or other non-visual indication of the location of the pin 110 relative to a specified location (e.g., the location of the device that is presenting the user interface 100, a user-specified location, the original location of the pin 110).

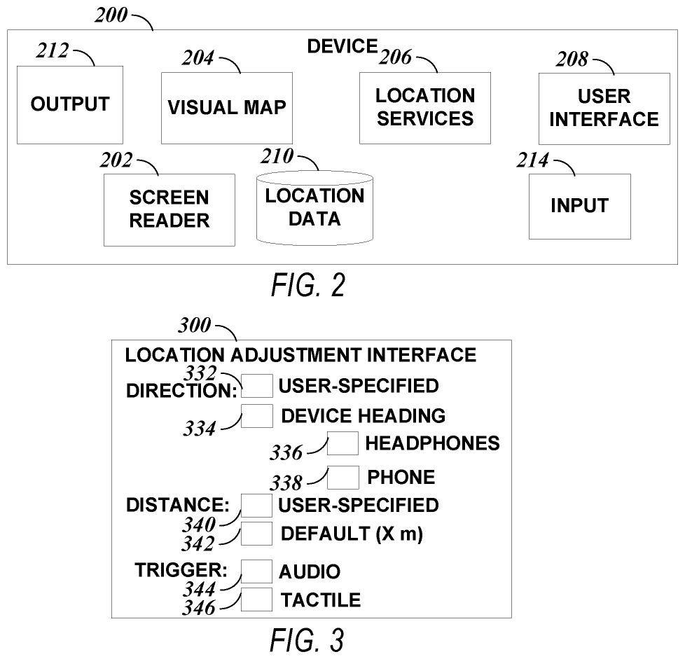

FIG. 2 illustrates, by way of example, a block diagram of an embodiment of a device 200 configured for location adjustment with a screen reader and direction audio. The device 200 as illustrated includes a screen reader program 202, a visual map program 204, an optional location services program 206, and an output component 212. The device 200 can be a smart phone, headset (e.g., an extended reality (e.g., augmented or virtual reality)) headset, smart glasses, a vehicle, an appliance, or the like.

While the programs 202, 204, 206 are illustrated as including the screen reader program 202, the visual map program 204, and the location services program 206, one or more of the programs 202, 204, 206 can be implemented by a second device to which the device 200 is communicatively connected. For example, some extender reality headsets (e.g., virtual, or augmented reality headsets) couple to another device that provides the functionality of programs that are not on the headset. Embodiments are applicable to such distributed systems.

The screen reader program 202 provides a user with an audio or tactile (e.g., braille or haptic) description of what is presented on the user interface 208. The screen reader program 202 is form of assistive technology that renders text and image content as a speed, braille, or other non-visual output and can receive audio or tactile input from the user. The screen reader program 202 can present the description of the user interface 208 using text-to-speech, sound icons, a braille device, a haptic motor, or the like. The screen reader program 202 can interact with an application programming interface (API), perform inter-process communication, query the user interface 208, or the like, to determine what is presented on the user interface 208. Screen reader programs and the operation of such programs is known. Example screen reader programs include NonVisual Desktop Access (NVDA), Job Access with Speech (JAWS), VoiceOver, Narrator, ZoomText/Fusion, System Access, ChromeVox, among many others.

The visual map program 204 can provide a view of a map or an image of a virtual or real region. The visual map program 204 allows a user to visually explore a space. The visual map program 204 can, via the location services program 206, provide turn-by-turn or other directions to a destination, descriptions of objects in the displayed region, or the like. Example visual map programs 204 include Google Maps, Apple Maps, Waze, Microsoft Soundscape, Maps.me, Lyft ridesharing app, Uber ridesharing app, among many others. The visual map program 204 can access and use location data 210, receive and use device location data from the location services program 206, or a combination thereof in performing operations.

The location services program 206 provides location information for the device 200. The location services program 206 can operate using global positioning services (GPS), Galileo, or other position determination services. The location information can indicate the location of the device 200. The location services program 206 can be used to 1) describe the location of pin 110 relative to the current location of the device (e.g., “pin 110 is 25 meters south of your current location”) and 2) allow the user to move the location of pin 110 relative to the location of the device (e.g., move the location of pin 110 in the direction of the device heading, move the location of pin 110 to the device's location). If the location services program 206 is not provided, then a user interface can still 1) describe the location of pin 110 using other context (e.g., “pin 110 is 15 meters north of original location” or “pin 110 is 5 meters west of Main Street & 1^{st} Ave intersection”) and 2) allow the user to move the location of pin 110 in a default direction (e.g., north, south, east, west or “move 2 meters west of Main Street & 1^{st} Ave intersection”, etc.).

Location data 210 can be local or remote to the device 200. The location data 210 indicates locations and corresponding descriptions of objects, attractions, type of object (e.g., building, address, use (e.g., bus stop, restaurant, bar, bathroom, etc.), or other data. The location data 210 can be accessed by the visual map program 204. The visual map program 204 can access the location data 210 in generating a visual, audio, or tactile description of the location or items about the location.

The user interface 208 provides the description of the location or items about the location to the user. The user interface 208 can be coupled to an output component 212, such as a display, haptic motor, speaker, or the like. The user interface 208 can provide the description of the location to the user by sending control signals to the output component 212. The user interface 208, through an input component 214 (e.g., a microphone, touchscreen, mouse, gaze tracker, keyboard, braille input component 214, or the like), allows the user to specify how the output is provided by the output component 212 and the configuration of the output provided by the output component 212. For example, the user can move the pin 110, using the input component 214. However, such input can be difficult, if not impossible, for a given user to operate with sufficient precision.

In some embodiments, the visual map program 204 interfaces with the output component 212 to provide direction-indicating audio to the user. The direction-indicating audio can include “spatial audio”, an express indication of the direction in natural language, or a coded indication of the direction. Spatial audio means that the audio sounds like it is coining from a certain direction. Spatial audio is possible with stereo speakers (e.g., headphones or other sound-emitting devices that work in concert to provide sound to respective eardrums of the user). The express indication of the direction indicates the direction in audio, braille, or other output. An express direction is “north”, “left”, “right”, “south”, “east”, “west”, “forward”, “backward”, a combination thereof, or the like. A coding of the direction can be set by a user or be default. An example coding is making a dog barking sound to indicate a first specified direction, a cat meow sound to indicate a second specified direction, and so on. The sound, tactile feedback, or the like can be configured to indicate a direction. Multiple sounds simultaneously can indicate combinations of directions. For example, a bark and meow can indicate “northwest” if the bark indicates north and the meow indicates west or vice versa. Alternatively, a different sound or tactile feedback can be provided to indicate each different direction.

The direction-indicating audio or tactile feedback provided by the output component 212 can be accompanied by a corresponding audio or tactile feedback indicating distance. Similar to the direction-indicating audio, the distance indicated can include “spatial audio”, an express indication of the distance in natural language, or a coded indication of the distance. In this case, spatial audio can be indicated such that the smaller the distance the louder the audio (or the quieter the audio). Express distance is a number followed by a unit. Coded distance is similar to the coded direction, except the noise indicates distance rather than direction.

The output component 212, under control of the visual map program 204, can provide an overall summary of the location of the pin 110 after movement. Verbal descriptions of the overall location can vary based on the given context but may include the orientation of the new location of the pin and distance to a major road or landmark (e.g., “location is 10 meters northwest of 150th Ave & NE 40th St intersection” or “location is 15 meters northwest of Building 99 Main Entrance”).

FIG. 3 illustrates, by way of example, a block diagram of a configuration menu 300 indicating different settings that can be default or user-specified. The configuration menu 300, while illustrated as a basic checkbox menu, can be presented with a variety of different configurations. The configurations can include radio buttons, drop-down menus, text input boxes (e.g., that can accept input using a keyboard, voice-to-text, tactile input (e.g., through a braille input component, touch screen, or the like), a dialog box, pull-down menu, or the like. The configurations, more generally, can include a natural language interface, question-and-answer interface, menu, form-fill interface, command-language interface, graphical user interface, among others.

The configuration menu 300 allows the user to specify how a direction in which to move the pin 110 is specified, a distance to move the pin 110, and a trigger that causes the pin 110 to be moved. The configuration menu 300 as illustrated includes direction options including user-specified 332 and device heading 334. The user-specified 332 direction option allows the user to provide data, via the input component 214, indicating the direction to move the pin 110. The user, through a microphone, for example, can state the direction to move the pin 110. The user-specified direction can be specified in terms of a natural language direction (e.g., “north”, “southwest”, “east northeast”, etc.), in terms of a natural language destination (e.g., “towards southeast corner of Main St and Putter Dr”, “in front of “Mom and Pop Café”, “in front of closest bus stop”, etc.), or the like.

The direction can be provided as a device heading 334. By selecting the device heading 334, the user can then orient their phone or other heading-aware device in the direction they would like to move the pin 110. The user can then provide a trigger (e.g., audio 344 or tactile 346 trigger) that causes the pin 110 to move in the direction indicated by the device heading 334. The device heading 334 can be provided by a phone 338 or another location-aware device-to-device communication device, such as a tablet, smartwatch, or the like. The device heading 334 can be provided by another heading-aware device, such as headphones 336.

The user can select the distance (on-the-ground) the pin 110 is moved responsive to sensing the trigger. The distance can be user-specified 340 or default 342. The user-specified 340 distance can be provided through the input component 214, such as by audio, text, or tactile input. The user can provide the distance in natural language, through a text input box, or the like. The default 342 distance can be five meters, ten meters, twenty-five meters, a greater or lesser distance, specified in different units, or a distance therebetween.

The user can specify a condition that triggers movement of the pin 110 (called a “trigger” herein). By defining a trigger condition, the user can set the distance, the heading, and then cause the pin 110 to move the amount and direction indicated by the distance and heading by performing the trigger. The trigger can be, for example, audio 344 or tactile 346. An audio trigger is a phrase, noise, or other utterance that can be detected by the device 200. The audio trigger can be default or user-specified. The tactile 346 trigger can include a tap, touchscreen input, braille device input, or the like. The tactile 346 trigger, like the audio 344 trigger, can be default or user-specified.

A user can alter a distance, direction, or trigger before, during, or after a change of the pin 110 location. A user can make the pin 110, or another marker, appear at the current location of the user using a default or user-specified audio or tactile input.

A user can snap the pin 110 to a different map feature of a map provided by the visual map program 204. For example, if the location being adjusted is near “Building 99”, then the user can have the option to “Move the pin to Building 99 Main Entrance”. In another example, if the location being adjusted is alongside a road, then the user can be presented with an option to snap the pin 110 to the closest location on that road, to the nearest intersection on that road, or to the nearest crosswalk, stop sign, stop light, or the like

The visual map program 204 can determine which features are relevant to present to the user given the current context. For example, the location of pin 110 can be described using nearby landmarks (e.g., “pin 110 is 10 meters north of building 114” or “pin 110 is 25 meters north of 1^{st} ST and Putter Drive”). In another example, the user can snap the location of the pin location to a nearby landmark (e.g., snap pin 110 to the closest intersection or building entrance).

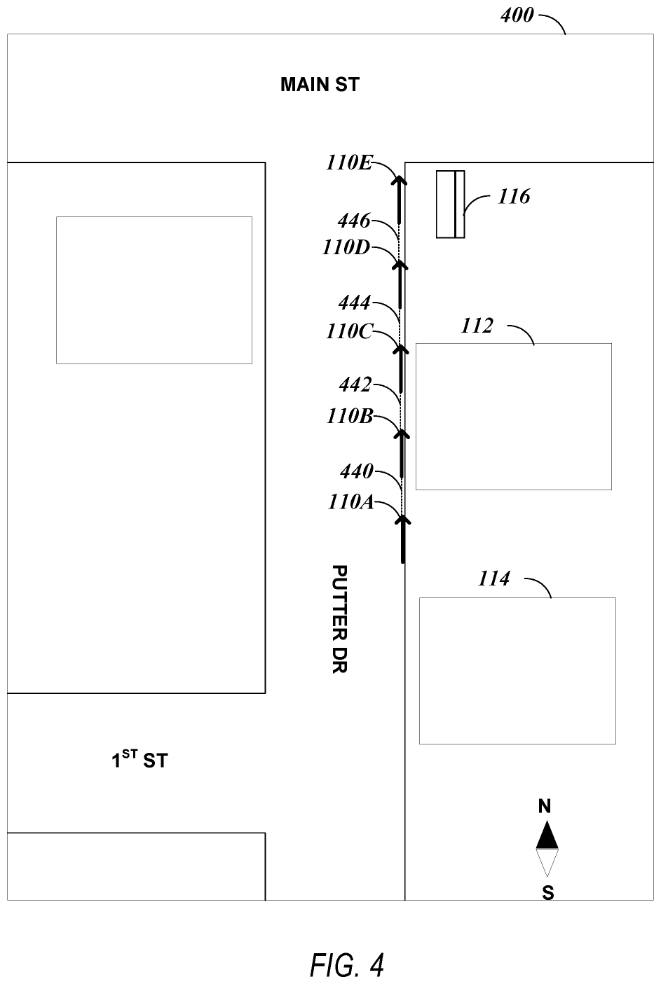

FIG. 4 illustrates, by way of example, a diagram of an embodiment of a user iteratively updating a location of the pin 110 on a user interface 400. The pin 110A represents an initial location of the pin 110, the pin 110E represents a final location for the pin 110 and the pins 110B, 110C, 110D, and 110E represent intermediate locations for the pin 110. The user can initiate dropping of the pin 110A by known means. The user can realize that the pin 110A is in the incorrect location. The user can desire to alter the location of the pin 110A by means other than those currently supported by many current visual map programs, like the tactile drag and drop. The user can indicate a direction in a manner controlled by input into the configuration menu 300 or a default direction can be used. In the example of FIG. 4, the direction is due north. The user can indicate a distance in a manner controlled by input into the configuration menu 300 or a default distance can be used. In the example, the distance corresponds to the length of each of the dashed lines 440, 442, 444, 446. The user can provide the trigger in a manner controlled by input into the configuration menu 300 or a default trigger. For example, the user can orient their phone due north and then provide the trigger, indicate “North” verbally, or the like. The pin 110B indicates the position of the pin 110 after a first detection of the trigger. The pin 110B moved the specified or default direction and specified or default distance responsive to the trigger. Moving the pin 110 in this manner can be more accessible as a user can specify how the pin 110 is moved. This allows users with disabilities to choose a pin movement trigger and distance and direction controls that are compatible with their disabilities. Some users without a disability may also find the configurability beneficial. Since the trigger can be different than the common drag-and-drop required of many visual map programs, the pin 110 movement can be performed by a wider variety of users including users with disabilities.

While FIG. 4 illustrates an iterative approach to moving the pin 110, embodiments are not limited to such an approach. For example, the distance and direction can be specified in a single command, such as “place the pin in front of the nearest bus stop”, or “place the pin near the southeast corner at the intersection of Main St. and Putter Dr.”, among others.

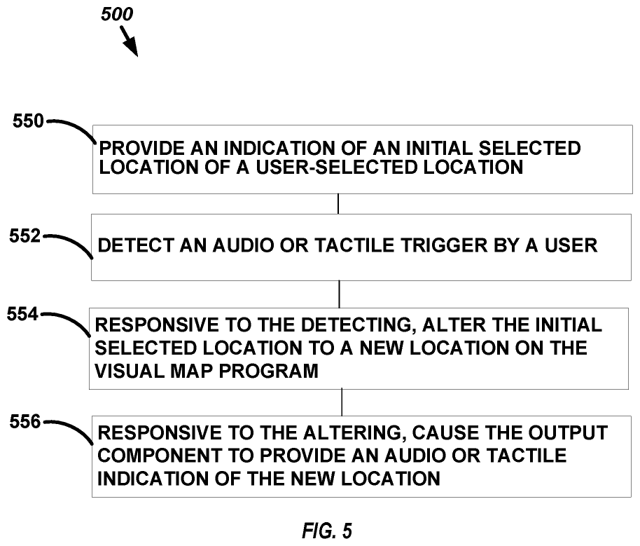

FIG. 5 illustrates, by way of example, a diagram of an embodiment of a method 500 for improved location-indicating pin updates. The method 500 as illustrated includes providing (e.g., by a screen reader program coupled to a visual map program) an indication of a user-selected precise location, at operation 550; detecting (e.g., by data provided by an input component) an audio or tactile trigger by a user, at operation 554; responsive to the detecting, altering (e.g., by a first distance and a first direction) the initial selected location to a new location on the visual map program, at operation 556; and responsive to the operation 554, causing an output component to provide an audio or tactile indication of the new location.

The input component can include a microphone or braille input component. The method can further comprise, responsive to the detecting, causing an output component to provide an audio or tactile indication of the new location. The output component can include a speaker, haptic motor, or a braille device. The visual maps program can cause the output component to provide the new location using spatial audio, express direction audio, or coded audio indicating the new location. The indication of the new location includes audio that indicates the new location relative to a tagged location on a map of the visual map program.

The distance can be user-specified through a user interface. The distance can be a default distance. The direction can be user-specified and the device can be heading-aware. The direction can be determined based on an orientation of the device. The direction can be a default direction. The method 500 can further include determining the new location is within a specified distance of a tagged location on the visual map. The method 500 can further include adjusting the coordinates of the new location to the location of the tagged location.

The foregoing description of embodiments is presented with regard to the pin 110 representing a location. The pin 110, however, is just a currently popular object used to indicate a location. The pin 110 is a display object that represents coordinates on a visual map. The pin 110 is thus optional. The location could simply be stored as coordinates and conveyed to the user in a non-visual or visual manner. For example, the location can be provided by conveying the location through a speaker, a haptic device, a braille device, or the like. Updating the location can include updating the stored coordinates associated with the location.

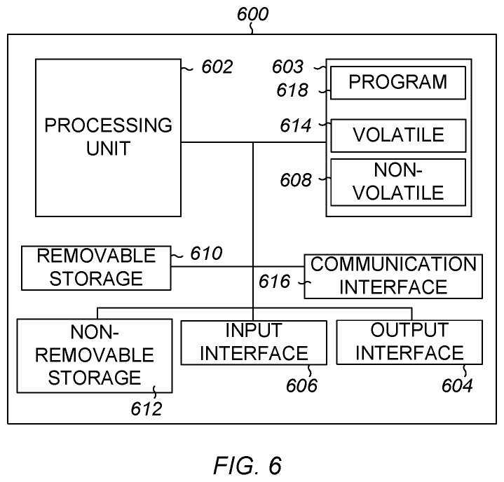

FIG. 6 illustrates, by way of example, a block diagram of an embodiment of a machine 600 (e.g., a computer system) to implement one or more embodiments. The device 200, configuration menu 300, or a component thereof, such as the screen reader program 202, visual map program 204, location services program 206, user interface 208, output component 212, input component 214, or the like, can include one or more of the components of the machine 600. One or more of the method 500 device 200, configuration menu 300, or a component thereof, such as the screen reader program 202, visual map program 204, location services program 206, user interface 208, output component 212, input component 214, or a component or operations thereof can be implemented, at least in part, using a component of the machine 600. One example machine 600 (in the form of a computer), may include a processing unit 602, memory 603, removable storage 610, and non-removable storage 612. Although the example computing device is illustrated and described as machine 600, the computing device may be in different forms in different embodiments. For example, the computing device may instead be a smartphone, a tablet, smartwatch, or other computing device including the same or similar elements as illustrated and described regarding FIG. 6. Devices such as smartphones, tablets, and smartwatches are generally collectively referred to as mobile devices. Further, although the various data storage elements are illustrated as part of the machine 600, the storage may also or alternatively include cloud-based storage accessible via a network, such as the Internet.

Memory 603 may include volatile memory 614 and non-volatile memory 608. The machine 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 600 may include or have access to a computing environment that includes input 606, output 604, and a communication connection 616. Output 604 may include a display device, such as a touchscreen, that also may serve as an input component. The input 606 may include one or more of a touchscreen, touchpad, mouse, keyboard, camera, one or more device-specific buttons, one or more sensors integrated within or coupled via wired or wireless data connections to the machine 600, and other input components. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 602 (sometimes called processing circuitry) of the machine 600. A hard drive, CD-ROM, and RAM are some examples of articles including a non-transitory computer-readable medium such as a storage device. For example, a computer program 618 may be used to cause processing unit 602 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware-based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on processing circuitry, such as can include a digital signal processor, ASIC, microprocessor, central processing unit (CPU), graphics processing unit (GPU), field programmable gate array (FPGA), or other type of processor operating on a computer system, such as a personal computer, server, or other computer system, turning such computer system into a specifically programmed machine. The processing circuitry can, additionally or alternatively, include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like). The terms computer-readable medium, machine readable medium, and storage device do not include carrier waves or signals to the extent carrier waves and signals are deemed too transitory.

### ADDITIONAL NOTES AND EXAMPLES

Example 1 includes a system comprising processing circuitry, an input component, an output component, and a memory including instructions that, when executed by the processing circuitry, cause the processing circuitry to perform operations for selected location update, the operations comprising providing, by a visual map program, an indication of an initial selected location of a user-selected location, detecting, by data provided by the input component, an audio or tactile trigger by a user, responsive to the detecting, altering, by a first distance and a first direction, the initial selected location to a new location on the visual map program, and responsive to the altering, causing the output component to provide an audio or tactile indication of the new location.

In Example 2, Example 1 can further include, wherein the input component includes a microphone or braille input component.

In Example 3, Example 1 can further include, wherein the output component includes a speaker, haptic motor, or a braille device.

In Example 4, at least one of Examples 1-3 can further include, wherein the visual maps program causes the output component to provide the new location using spatial audio, express direction audio, or coded audio indicating the new location.

In Example 5, at least one of Examples 1-4 can further include, wherein the indication of the new location includes audio that indicates the new location relative to a tagged location on a map of the visual map program.

In Example 6, at least one of Examples 1-5 can further include a user interface, and wherein the distance is user-specified through the user interface.

In Example 7, at least one of Examples 1-6 can further include, wherein the distance is a default distance.

In Example 8, at least one of Examples 1-7 can further include, wherein the direction is user-specified and the device is heading-aware, wherein the direction is determined based on an orientation of the device.

In Example 9, at least one of Examples 1-8 can further include, wherein the direction is a default direction.

In Example 10, at least one of Examples 1-9 can further include determining the new location is within a specified distance of a tagged location on the visual map and adjusting the coordinates of the new location to the location of the tagged location.

Example 11 includes a method to perform the operations of the method of at least one of Examples 1-10.

Example 12 includes a machine-readable medium including instructions that, when executed by a machine, cause the machine to perform operations of the method of Example 11.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A system comprising:
processing circuitry;
an input component;
an output component; and
a memory including instructions that, when executed by the processing circuitry, cause the processing circuitry to perform operations for selected location update, the operations comprising:
providing, by a visual map program, an indication of an initial selected location of a user-selected location;
detecting, by data provided by the input component, an audio or tactile trigger by a user;
responsive to the detecting, altering, by a first distance and a first direction, the initial selected location to a new location on the visual map program; and
responsive to the altering, causing the output component to provide an audio or tactile indication of the new location.

2. The system of claim 1, wherein the input component includes a microphone or braille input component.

3. The system of claim 1, wherein the output component includes a speaker, haptic motor, screen reader, or a braille device.

4. The system of claim 1, wherein the visual maps program causes the output component to provide the new location using spatial audio, express direction audio, or coded audio indicating the new location.

5. The system of claim 1, wherein the indication of the new location includes audio that indicates the new location relative to a tagged location on a map of the visual map program.

6. The system of claim 1, further comprising a user interface, and wherein the distance is user-specified through the user interface.

7. The system of claim 1, wherein the distance is a default distance.

8. The system of claim 1, wherein the direction is user-specified and the device is heading-aware, wherein the direction is determined based on an orientation of the device.

9. The system of claim 1, wherein the direction is a default direction.

10. The system of claim 1, further comprising, determining the new location is within a specified distance of a tagged location on the visual map and adjusting the coordinates of the new location to the location of the tagged location.

11. A method for selected location update, the method comprising:
providing, by a visual map program, an indication of an initial selected location of a user-selected location;
detecting, by data provided by the input component, an audio or tactile trigger by a user;
responsive to the detecting, altering, by a first distance and a first direction, the initial selected location to a new location on the visual map program; and
responsive to the altering, causing the output component to provide an audio or tactile indication of the new location.

12. The method of claim 11, wherein the visual maps program causes the output component to provide the new location using spatial audio, express direction audio, or coded audio indicating the new location.

13. The method of claim 11, wherein the indication of the new location includes audio that indicates the new location relative to a tagged location on a map of the visual map program.

14. The method of claim 11, and wherein the distance is user-specified through a user interface.

15. The method of claim 11, wherein the distance is a default distance.

16. The method of claim 11, wherein the direction is user-specified and the device is heading-aware, wherein the direction is determined based on an orientation of the device.

17. The method of claim 1, wherein the direction is a default direction.

18. A non-transitory machine-readable medium including instructions that, when executed by a machine, cause the machine to perform operations for selected location update, the operations comprising:
providing, by a visual map program, an indication of an initial selected location of a user-selected location;
detecting, by data provided by the input component, an audio or tactile trigger by a user;
responsive to the detecting, altering, by a first distance and a first direction, the initial selected location to a new location on the visual map program; and
responsive to the altering, causing the output component to provide an audio or tactile indication of the new location.

19. The machine-readable medium of claim 18, wherein the input component includes a microphone or braille input component.

20. The machine-readable medium of claim 18, wherein the output component includes a speaker, haptic motor, screen reader, or a braille device.
